(19) United States
(12) Patent Application Publication
(10) Pub. No.: US 2007/0148303 A1
(43) Pub. Date: Jun. 28, 2007

(54) SUGAR FREE AERATED CONFECTION

(76) Inventors: Scott J. Yeager, Bethlehem, PA (US); Sylvia J. Coyle, Birchwood, TN (US); Shannon Birosik, Northampton, PA (US)

Correspondence Address: NORRIS MCLAUGHLIN & MARCUS, P.A., P O BOX 1018, SOMERVILLE, NJ, 08876, US

(21) Appl. No.: 11/561,560

(22) Filed: Nov. 20, 2006

Related U.S. Application Data
(60) Provisional application No. 60/740,363, filed on Nov. 29, 2005.

(51) Int. Cl. A23L 1/00

(52) U.S. Cl. 426/564

(57) ABSTRACT

Sugar free aerated confections comprising water, hydrogenated starch hydrolysate, hydrogenated saccharide, sugar alcohol, whipping agent and an ionic bridge having one or more metal salts. Also, processes for making the sugar free aerated confection.

### CROSS REFERENCE TO RELATED APPLICATION

This application claims the benefit of U.S. Provisional Application No. 60/740,363 filed Nov. 29, 2005, which is incorporated herein in its entirety by reference.

### BACKGROUND OF THE INVENTION

1. Field of the Invention

The invention relates to aerated confections, such as marshmallow and nougat, which do not contain sugar. The invention further pertains to a method for making the sugar free aerated confections.

2. The Related Art

Aerated confections, such as marshmallow and nougat, are among the most difficult confections to make. The marshmallow confection, for example, was originally made from the root of the marsh mallow plant. On an industrial basis, however, the marshmallow confection is best known as an aerated soft, spongy water based confection made from sugar, starch, corn syrup and gelatin. To successfully manufacture a marshmallow, the appropriate blend of crystallized and dissolved carbohydrates in conjunction with a whipping agent must be achieved. Absent the proper blend, a marshmallow confection having the appropriate density, stability, taste and texture is difficult to manufacture.

Making a sugar free aerated confection, such as a sugar free marshmallow or nougat, having the appropriate density, stability, taste and texture is traditionally thought to be more difficult than making conventional aerated confections with sugar. This may be due to the hygroscopicity and solubility of polyhydric alcohols, such as sorbitol, which may be used as sweetener and bulking agent in the sugar free confections. Refinement of the raw materials used for sugar free confections are a further impediment to making sugar free aerated confections, having the appropriate density, stability, taste and texture. This may explain why, despite the current proliferation of sugar free chocolates, confections and candies, there are few if any sugar free aerated confections, such as sugar free marshmallow or nougat, in the art. An aerated confection, such as a marshmallow or nougat, containing no sugar but having the appropriate density, stability and organoleptic properties, such as taste and texture, of aerated confections comprising sugar is highly desirable.

### SUMMARY OF THE INVENTION

The invention is a sugar free aerated confection comprising water, hydrogenated starch hydrolysate, hydrogenated saccharide, sugar alcohol and whipping agent. The sugar free aerated confection further comprises an ionic bridge having one or more metal salts, such as calcium chloride. The sugar free aerated confection may further comprise sugar free sweeteners, such as an intense sweetener, like sucralose, flavorings, colorants and fillers. For purposes of this specification and the appended claims, the terms “sugar free” and “sugar less” shall mean without sugar or sugar sweeteners.

The sugar free aerated confection is made by first combining the hydrogenated starch hydrolysate, hydrogenated saccharide and sugar alcohol to form a slurry. After the slurry is formed, the other ingredients, such as the whipping agent, sugar free sweetener, flavorings, colorants and fillers are blended with the slurry to obtain a sugar free candy mass. The candy mass may be aerated, unless it is sufficiently foamed or aerated from other processing steps. The components of the ionic bridge may be added at the time the slurry is formed to become a component of the slurry or at any time in the process prior to foaming or aeration. Optionally, the sugar free aerated confection may be molded into a product shape; however, the aerated confection may be used as a component of another candy or confection, or a food item, like a cookie, cake or frozen confection. The sugar free aerated confection may optionally be coated, such as after it is formed into a product shape, such as by molding or extruding and/or cutting.

All parts and percentages set forth in this specification and the appended claims are on a weight by weight basis (i.e., by weight of the composition or by weight of the sugar free aerated confection) unless stated otherwise.

### DETAILED DESCRIPTION OF THE INVENTION

The invention pertains to a sugar free aerated confection comprising water, hydrogenated starch hydrolysate, hydrogenated saccharide, sugar alcohol and whipping agent. The sugar free aerated confection may further comprise a sugar free sweetener, such as an intense sweetener, flavorings, colorants and fillers. The sugar free aerated confection is preferably a marshmallow, although the invention also encompasses other types of sugar free aerated confections, such as nougats. The sugar free aerated confection may consist essentially of or consist of its components.

In an embodiment of the invention the sugar free aerated confection comprises a) about 10% to about 25% water, b) about 10% to about 30% hydrogenated starch hydrolysate, c) about 5% to about 50%, preferably from about 5% to about 15%, hydrogenated saccharide, d) about 5% to about 95%, preferably about 10% to about 95%, such as about 35% to about 95%, sugar alcohol and e) about 2% to about 10% whipping agent. The sugar free aerated confection may further comprise up to about 0.5% intense sweetener, such as from about 0.1% to about 0.5% intense sweetener. Also, the sugar free aerated confection may comprise from about 0.1% to about 5.0% flavoring.

In addition to the aforementioned components, the sugar free aerated confection comprises an ionic bridge. The ionic bridge generally comprises one or more metal salts preferably in solution with solvent, such as water; however, the ionic bridge may consist of one or more metal salts, such as one or more metal salts in anhydrous or dry form, or consist essentially of the metal salts. Metal salts useful for the ionic bridge include those selected from the group consisting of calcium chloride, sodium chloride, sodium hexametaphosphate, potassium chloride, magnesium chloride, magnesium phosphate, and the like, and combinations thereof. In an embodiment of the invention, the metal salt is selected from the group consisting of calcium chloride, sodium chloride, magnesium chloride or combinations thereof, and the metal salt may be calcium chloride or magnesium chloride. Anhydrous calcium chloride (CALTAC, F.C.C.) available from Mallinckrodt Laboratory Chemicals (“Mallinckrodt”), a division of Mallinckrodt Baker, Inc., Phillipsburg, N.J., USA, may be used, particularly as a component in solution with water such that the ionic bridge is a solution of calcium chloride in water.

The ionic bridge component of the sugar free aerated confection is necessary to the formation of the sugar free aerated confection having the appropriate density, stability and organoleptic properties, such as taste and texture, of aerated confections comprising sugar. The inclusion of the ionic bridge, particularly the ion, provides a bridge between the slurry and the whipping agent during processing which permits the creation of an emulsion of candy mass comprising the whipping agent which allows the candy mass to whip and aerate during processing. Absent the ionic bridge, the components of the confection and whipping agent do not properly form an emulsion and, thus, it becomes difficult, if not impossible, to aerate and obtain the sugar free aerated confection. The preferred density for the sugar free aerated confection is from about 0.20 g/cm³ and about 0.50 g/cm³.

The amount of metal salt most effective for achieving the function of the ionic bridge varies depending on the particular metal salts used in the sugar free aerated confection. For example, when calcium chloride is used, this metal salt is most effective when used in an amount of from about 0.20% to about 2.00% weight of the sugar free aerated confection, preferably about 0.50% to about 1.75%, such as about 0.50% to about 1.5%, like about 0.50%. With other metal salts useful in the ionic bridge, the amounts may be as follows: sodium chloride from about 0.50% to about 1.00%, preferably about 0.75% to about 1.25%, like about 1.00%, sodium hexametaphosphate from about 1.00% to about 4.00%, preferably about 1.00% to about 2.00%, like about 2.00%, potassium chloride from about 0.50% to about 1.00%, preferably about 1.00%, magnesium chloride from about 0.50% to about 3.00%, preferably about 0.50% to about 2.60%, such as about 0.5% to about 1.75%, like about 1.00%, and magnesium phosphate from about 1.00% to about 4.00%, preferably about 1.00% to about 2.00%, like about 2.00%, all by weight of the sugar free aerated confection. Use of one or more of the metal salts in these amounts were found to be most effective in obtaining an aerated confection having the desired properties, particularly a confection with the preferred density range of about 0.20 g/cm³ and about 0.50 g/cm³.

Hydrogenated starch hydrolysates are generally obtained through partially hydrolyzing starch, such as corn, wheat or potato starch, and then hydrogenating the hydrolyzed starch at high temperature under pressure. Any type of hydrogenated starch hydrolysate may be used in the sugar free aerated confection. Examples of hydrogenated starch hydrolysates preferably used in the invention include those comprising maltitol, sorbitol, and, optionally, high molecular weight polymers. The hydrogenated starch hydrolysates generally have less than about 50% maltitol. Hydrogenated starch hydrolysates useful in the invention include those having about 5% to about 30% sorbitol, such as about 15% sorbitol; about 10% to about 40% maltitol, such as about 20% maltitol and about 30% to about 80% hydrogenated trisaccharides and saccharides higher than tri, such as about 65% hydrogenated trisaccharides and saccharides higher than tri. This hydrogenated starch hydrolysate may comprise from about 5% to about 30% hydrogenated trisaccharides, such as about 11% hydrogenated trisaccharides, and about 40% to about 70% hydrogenated tetra- and higher saccharides, such as about 54% tetra- and higher saccharides. Polyol solutions available from SPI Polyols, Inc., New Castle, Del., USA (“SPI Polyols”) under the trade name HYSTAR®, including HYSTAR® 3375, may be used in the sugar free aerated confections of the invention. Other hydrogenated starch hydrolysates useful in the invention include those comprising from about 6% to about 10% sorbitol, from about 25% to about 55% hydrogenated disaccharides, from about 20% to about 40% hydrogenated tri- to hepta-saccharides, and from about 15% to about 30% hydrogenated-saccharides higher than hepta, as well as those comprising from about 8% to about 20% sorbitol, from about 5% to about 15% hydrogenated disaccharides, and from about 2% to about 75% hydrogenated tri- to penta-saccharides.

Any hydrogenated saccharide may be used in the sugar free aerated confection; however, the hydrogenated saccharide preferably comprises sorbitol and mannitol. An example of a hydrogenated saccharide useful in the invention is isomalt which comprises an equimolar mixture of alpha-D-glucopyranosido-1,6-sorbitol and alpha-D-glucopyranosido-1,6-mannitol such as that described in U.S. Pat. No. 4,117,173. Isomalt available under the trade name PALATINIT® from PALATINIT® of America, Inc., Morris Plains, N.J. USA may be used. Hydrogenated saccharides may also comprise maltitol and lactitol.

Sugar alcohol, or polyols or polyhydric alcohol, are generally hydrogenated forms of carbohydrates. Any sugar alcohol may be used in the sugar free aerated confection, but the sugar alcohols most useful in the invention include mannitol, sorbitol, xylitol, maltitol, lactiol, and the like, and combinations thereof. Particularly preferred are maltitol and sorbitol, and combinations thereof. For example, a sugar alcohol composition, such as syrup, comprising from about 85% to about 99% maltitol and about 0.1% to about 10% sorbitol may be used, including a composition comprising greater than about 90% maltitol and less than about 2% sorbitol. Maltitol syrup like that available from SPI Polyols under the trade name MALTISWEET™, including MALTISWEET™ M95, may be used in the invention. In an embodiment of the invention, the sugar free aerated confection comprises from about 30% to about 90% of a sugar alcohol composition comprising greater than about 90% maltitol and less than about 2% sorbitol. Also, a sorbitol solution comprising from about 55% to about 80% sorbitol in solution with water, including those comprising about 60% to about 70% sorbitol, like about 64% sorbitol, may be used. A sorbitol solution available from SPI Polyols under the trade name SORBO™ 70 may be used for the sugar free aerated confection, and in embodiments of the invention the sugar free aerated confection may comprise from about 5% to about 50% of a 70% sorbitol solution.

The sugar free aerated confection composition comprises a whipping agent (aerating agent), which generally provides for the aeration of the candy mass during the manufacturing process. Whipping agents may be gelatin, vegetable protein, such as soy protein, egg whites and the like. Whipping agents useful in the invention may further include egg albumen, milk proteins and caseinates, such as sodium caseinate and whey protein, and mixtures thereof and hydrocolloids or colloids such as pectin, modified starches, edible gums and mixtures thereof. The preferred whipping agent is gelatin. Gelatin may be derived from bovine, porcine, or piscine (fish) sources, such as skin or bones and can be gelatins derived from mixtures of such sources. Preferred gelatins are those derived from bovine, porcine, or piscine (fish) sources having bloom strength from about 200 to about 275. An example of gelatin useful in the invention is ROUSSELOT® 275 A30 edible gelatin available from System Bio Industries, Inc., Waukesha, Wis., USA (“SBI”).

The sugar free sweetener component of the sugar free aerated confection composition may be an intense sweetener or other sugar free sweetener such as polyhydric alcohols like sorbitol, mannitol, xylitol, hydrogenated starch hydrolysates, maltitol, isomalt, erythritol, and the like and combinations thereof. These may be used as the sugar free sweetener component, even if the same material is used as the hydrogenated starch hydrolysate, hydrogenated saccharide or sugar alcohol component discussed above. Preferably, however, the sugar free sweetener component is an intense sweetener (which may also be referred to as a high potency sweetener), including those selected from the group consisting of sucralose, aspartame, saccharin, cyclamate, thaumatin, dihydrochalcones, acesulfame K compounds, neotame, alitame, glycyrrhizin, and stevioside and the like, and combinations thereof. The intense sweetener most preferred for use in the invention is sucralose, which is available under the trade name SPLENDA® from McNeil Nutritionals, LLC, Ft. Washington, Pa., USA. The sugar free sweetener, i.e. the intense sweetener, may be used in a solution with water, like one comprising from about 1% to about 99% sugar free sweetener, including a 25% solution of sucralose, such as a 25% solution of SPLENDA® from McNeil Nutritionals, LLC.

Flavoring agents useful for the invention are any food grade or pharmaceutically acceptable flavoring agent, and the specific flavoring agent or agents will depend on the desired taste. The flavoring agent may be vanilla, cocoa, chocolate, fruit, spice or mint flavoring. The flavoring agent may be natural or artificial or combinations thereof. Suitable flavoring agents may comprise flavor oils, including acids, such as adipic, succinic, malic and fumaric acid, citrus oils, such as lemon oil, orange oil, lime oil, grapefruit oil, fruit essences, such as apple essence, pear essence, peach essence, strawberry essence, apricot essence, raspberry essence, cherry essence, plum essence, pineapple essence, and also essential oils like peppermint oil, spearmint oil, mixtures of peppermint oil and spearmint oil, clove oil, bay oil, anise oil, eucalyptus oil, thyme oil, cedar leaf oil, cinnamon oil, oil of nutmeg, oil of sage, oil of bitter almonds, cassia oil, and methylsalicylate (oil of wintergreen). Also, the flavoring agent may comprise cooling agents such as menthol, N-substituted p-menthane-3-carboxamides (such as N-ethyl p-menthane-3-carboxamide), 3,1-methoxy propane 1,2-diol and the like, or combinations thereof. Combinations of flavoring agents can be used. For marshmallow aerated confections, natural vanilla extract or artificial vanilla flavoring is most preferred, as well as natural or artificial chocolate flavor.

The colorant or coloring agent may be any food grade and/or pharmaceutically acceptable colorant or coloring agent. Examples of colorants or coloring agents useful for the invention include Food, Drug and Cosmetic (FD&C) colorants such as primary dyes FD&C Blue No. 1, FD&C Blue No. 2, FD&C Green No. 3, FD&C Yellow No. 5, FD&C Yellow No. 6, FD&C Red No. 3 and FD&C Red No. 40, and lakes FD&C Blue No. 1, FD&C Blue No. 2, FD&C Yellow No. 5, FD&C Yellow No. 6, FD&C Red No. 40 and combinations thereof. Like colorants and dyes may also be used, as well as natural colorants and/or dyes.

The sugar free aerated confection is generally made in at least a two step process. First, the sugar alcohol, hydrogenated starch hydrolysate, hydrogenated saccharide and water are formed into a slurry. The slurry is cooked. For example, the slurry may be cooked to a desired solids content, such as at about 245° F. to about 265° F. to obtain a dry solids content of about 85% to about 95%, although other cooking temperatures and desired dry solids content are within the scope of the invention. Either after cooking or during the cooking process, the whipping agent, intense sweetener, flavorings, colorants and other ingredients or fillers, and optional additional water, are added and blended with the slurry, optionally under agitation and/or at a temperature below the cooking temperature, to form an emulsified candy mass. In an embodiment of the invention, after the candy mass is formed it is held and allowed to cool below the cooking temperature, for example to a temperature below about 240° F., such as about 160° F. to about 230° F. The candy mass is then, optionally, aerated, preferably after cooling below the slurry cooking temperature. Examples of aerating gases which may be used and ingested into the candy mass to aerate and form the aerated confection are air, nitrogen, nitrogen dioxide, carbon dioxide and the like, and combinations thereof. The components may be combined in the compositional amounts for the components as discussed above with respect to the composition. The components of the ionic bridge are added to the composition prior to cooking when the slurry is formed, during the cooking or at any step in the process to emulsify the candy mass. Preferably the ionic bridge is added at any point prior to aeration in embodiments where the emulsified candy mass is aerated.

The aerated confection may, optionally, be formed into a product shape such as a cube, cylinder, animal or novelty shape for sale to consumers. The aerated confection may be formed into a product shape, preferably after aeration, by means selected from the group consisting of molding, extruding, cutting and combinations thereof. In addition, the sugar free aerated confection can be used as an ingredient or component of a confection, candy, cake or other food item, such as marshmallow portion of a candy bar, cookie, cake or frozen confection.

The sugar free aerated confection may be coated with a coating or dusting agent, examples of which are hydrogenated starch hydrolysates, hydrogenated saccharide, starches, or gums (like Gum Arabic). Other types of coating materials like chocolate or sugar free chocolate may be used. Preferably, the coating is isomalt due to its very low solubility. In an embodiment of the invention, the same hydrogenated starch hydrolysate or hydrogenated saccharide is used for the coating, as used in the candy mass to make the sugar free aerated confection. For example, when the candy mass comprises isomalt as the hydrogenated saccharide, the aerated confection is preferably coated, if at all, with isomalt as this tends to decrease moisture migration (i.e. moisture loss within the sugar free aerated confection) or syneresis, which would lead to instability of the sugar free aerated confection.

In an embodiment of the invention, the sugar free aerated confection is treated with steam prior to or simultaneous with the coating of the sugar free aerated confection by exposing the outer surface of the sugar free aerated confection to steam. For example, the sugar free aerated confection is treated with steam at about 2 psi to about 15 psi for about 2 seconds to about 10 seconds in order to effectively coat the confection as discussed above. The steam treatment may be performed immediately prior to coating the confection such that the treatment occurs after the candy mass is aerated but prior to coating. Most preferably, the steam treatment is applied when the sugar free aerated confection is formed into a product shape and is performed after the product shape is formed but before or simultaneously with coating the product shape.

With conventional aerated confections treatment with steam is not necessary in order to have the coating adhere to the outside of the confection. Without being bound by any theory, the inventors believe that, when the sugar free aerated confection is prepared, the outer surface of the confection tends to develop a skin which impairs the ability of the surface to become coated, i.e., the skin impairs the ability of the coating material to adhere to the outer surface of the sugar free aerated confection. When the sugar free aerated confection is treated with steam, such as in a high humidity chamber, the coating is able to adhere to outer surfaces of the sugar free aerated confection, notwithstanding the skin formation. The preferred coating material in this embodiment is isomalt, although the other coating materials discussed herein may be used.

The invention pertains to a sugar free aerated confection comprising an ionic bridge having at least one or more metal salts, hydrogenated starch hydrolysate, hydrogenated saccharide, sugar alcohol, whipping agent and water. The invention further pertains to a process for making a sugar free aerated confection which, in an embodiment, comprises the steps of a) combining an ionic bridge having at least one or more metal salts, hydrogenated starch hydrolysate, hydrogenated saccharide, sugar alcohol and water to from a slurry, b) combining the slurry with whipping agent, water and, optionally, sugar free sweetener, flavoring and fillers to obtain a candy mass, and c) optionally aerating the candy mass. The process may further comprise the step of coating the sugar free aerated confection.

### EXAMPLE 1

A sugar free marshmallow having the components set forth in Table 1 was prepared.

TABLE 1

| | % Formula |
|---|---|
| Slurry Ingredients | |
| Water | 8.04 |
| MALTISWEET ™ M95 Maltitol | 65.56 |
| Syrup (SPI Polyols) | |
| HYSTAR ® 3375 Polyglycitol | 15.39 |
| Syrup (SPI Polyols) | |
| PALANTINIT ® Isomalt STF | 15.11 |
| Sorbitol Syrup | 14.25 |
| (SPI Polyols SORBO ™ 70) | |
| Mallinckrodt Calcium Chloride | 1.45 |
| (CALTAC) Solution | |
| Moisture Loss | −33.73 |
| Other Ingredients | |
| Water | 10.08 |
| ROUSSELOT ® 275 A30 | 3.73 |
| Edible Gelatin (SBI) | |
| SPLENDA ® (25% solution | 0.02 |
| sucralose) | |
| Flavoring (Vanilla blend) | 0.10 |
| Total | 100.00 |

The slurry ingredients were combined and cooked with mixing at 254° F. to drive off water and provide a cooked slurry with about 93.5% dry solids content. The other ingredients were then blended with the cooked slurry with stirring at 240° F. to obtain a candy mass. The candy mass was held in a holding tank and cooled to about 175° to 185° F.

The candy mass was aerated with air at about 0.28 to about 0.30 grams/cm³ and 150° F. using a VL-50 MONDOMIX® aerator from Haas-Mondomix B.V., Almere, The Netherlands to obtain a sugar free aerated marshmallow. The marshmallow was molded into a product shape and coated with isomalt, PALANTINIT® Isomalt STF.

### EXAMPLE 2

Sugar free marshmallows having an ionic bridge comprising calcium chloride solution (50% solution) in varying amounts of 0.50%, 1.0%, 2.0% and 4.0% of the formula were prepared in accordance with the procedure described above for Example 1. The compositions of the four sugar free marshmallows having 0.50%, 1.0%, 2.0% and 4.0% calcium chloride solution prepared for Example 2 are set forth in Table 2A.

TABLE 2A

| | % Formula |
|---|---|
| Slurry Ingredients | |
| Water | 8.04 |
| MALTISWEET ™ M95 Maltitol | 65.56 |
| Syrup (SPI Polyols) | |
| HYSTAR ® Polyglycitol Syrup | 15.39 |
| (SPI Polyols) | |
| PALANTINIT ® Isomalt STF | 15.11 |
| SORBO 70 ™ M95 Sorbitol Syrup | 14.25 |
| (SPI Polyols) | |
| Calcium Chloride Solution | 0.50-4.00 |
| Moisture Loss | −33.73 |
| Other Ingredients | |
| Water | 10.08 |
| ROUSSELOT ® 275 A30 | 3.73 |
| Edible Gelatin (SBI) | |
| SPLENDA ® (25% Solution | 0.02 |
| Sucralose) | |
| Flavoring Vanilla Blend | 0.10 |
| TOTAL: | ˜100.00 |

The sugar free marshmallows having the varying amounts of calcium chloride solution were subjected to taste tests wherein a taste panel ingested a portion of each sugar free marshmallow and made observations regarding the sensations for saltiness and aeration. The results are discussed in Table 2B below.

TABLE 2B

| % Formula | |
|---|---|
| Calcium Chloride Solution | Reported as having: |
| 0.50 | No saltiness and acceptable aeration |
| 1.0 | No saltiness and acceptable aeration |
| 2.0 | Low to moderate saltiness and acceptable |
| | aeration |
| 4.0 | High saltiness and acceptable aeration |

### EXAMPLE 3

Sugar free marshmallows having an ionic bridge comprising sodium chloride solution (50% solution) in amounts of 1.0% and 2.0% by weight of the composition were prepared in accordance with the procedure described above for Example 1. The compositions of the two sugar free marshmallows having 1.0% and 2.0% sodium chloride solution prepared for Example 3 is set forth in Table 3A.

TABLE 3A

| | % Formula |
|---|---|
| Slurry Ingredients | |
| Water | 7.99 |
| MALTISWEET ™ M95 Maltitol | 65.56 |
| Syrup (SPI Polyols) | |
| HYSTAR ® Polyglycitol Syrup | 15.39 |
| (SPI Polyols) | |
| PALANTINIT ® Isomalt STF | 15.11 |
| SORBO 70 ™ M95 Sorbitol Syrup | 14.25 |
| (SPI Polyols) | |
| Calcium Chloride Solution | 1.0-2.0 |
| Moisture Loss | −33.73 |
| Other Ingredients | |
| Water | 10.08 |
| ROUSSELOT ® 275 A30 | 3.73 |
| Edible Gelatin (SBI) | |
| SPLENDA ® (25% Solution | 0.02 |
| Sucralose) | |
| Flavoring Vanilla Blend | 0.10 |
| TOTAL: | ˜100.00 |

The sugar free marshmallows having 1.0% and 2.0% sodium chloride solution were subjected to taste tests wherein a taste panel ingested a portion of each sugar free marshmallow and made observations regarding the sensations for saltiness and aeration. The results are discussed in Table 3B below.

TABLE 3B

| % Formula | |
|---|---|
| Sodium Chloride Solution | Reported as having: |
| 1.0 | Moderate saltiness and low aeration |
| 2.0 | High saltiness and good aeration |

### EXAMPLE 4

Sugar free marshmallows having an ionic bridge comprising magnesium chloride solution (50% solution) in amounts of 1.0% and 2.6% by weight of the composition were prepared in accordance with the procedure described above for Example 1. The compositions of the two sugar free marshmallows having 1.0% and 2.6% magnesium chloride solution prepared for Example 4 is set forth in Table 4A.

TABLE 4A

| | % Formula |
|---|---|
| Slurry Ingredients | |
| Water | 8.49 |
| MALTISWEET ™ M95 Maltitol Syrup | 65.56 |
| (SPI Polyols) | |
| HYSTAR ® Polyglycitol Syrup (SPI | 15.39 |
| Polyols) | |
| PALANTINIT ® Isomalt STF | 15.11 |
| SORBO 70 ™ M95 Sorbitol Syrup (SPI | 14.25 |
| Polyols) | |
| Magnesium Chloride Solution | 1.00-2.60 |
| Moisture Loss | −33.73 |
| Other Ingredients | |
| Water | 10.08 |
| ROUSSELOT ® 275 A30 Edible Gelatin | 3.73 |
| (SBI) | |
| SPLENDA ® (25% Solution Sucralose) | 0.02 |
| Flavoring Vanilla Blend | 0.10 |
| TOTAL: | ˜100.00 |

The sugar free marshmallows having 1.0% and 2.6% magnesium chloride solution were subjected to taste tests wherein a taste panel ingested a portion of each sugar free marshmallow and made observations regarding the sensations for saltiness and aeration. The results are discussed in Table 4B below.

TABLE 4B

| % Formula | |
|---|---|
| Magnesium Chloride Solution | Reported as having: |
| 1.0 | No saltiness and good aeration |
| 2.6 | No saltiness and good aeration |

We claim:

1. A sugar free aerated confection comprising water, hydrogenated starch hydrolysate, hydrogenated saccharide, sugar alcohol, whipping agent and an ionic bridge comprising one or more metal salts.

2. The sugar free aerated confection of claim 1 wherein the metal salts are selected from the group consisting of calcium chloride, sodium chloride, sodium hexametaphosphate, potassium chloride, magnesium chloride, magnesium phosphate, and combinations thereof.

3. The sugar free aerated confection of claim 1 wherein the metal salts are selected from the group consisting of about 0.20% to about 2.00% calcium chloride, about 0.50% to about 1.00% sodium chloride, about 1.00% to about 4.00% sodium hexametaphosphate, about 0.50% to about 1.00% potassium chloride, about 0.50% to about 3.00% magnesium chloride, about 1.00% to about 4.00% magnesium phosphate, and combinations thereof.

4. The sugar free aerated confection of claim 1 wherein the metal salts are selected from the group consisting calcium chloride, sodium chloride, magnesium chloride and combinations thereof.

5. The sugar free aerated confection of claim 1 further comprising intense sweetener, flavoring, colorant and fillers.

6. The sugar free aerated confection of claim 1 having a density of about 0.20 g/cm³ to about 0.50 g/cm³.

7. The sugar free aerated confection of claim 1 wherein the hydrogenated starch hydrolysate comprises about 5% to about 30% sorbitol, about 10% to about 40% maltitol, and about 30% to about 80% hydrogenated trisaccharides and saccharides higher than tri.

8. The sugar free aerated confection of claim 1 wherein the hydrogenated saccharide comprises sorbitol and mannitol or maltitol and lactitol.

9. The sugar free aerated confection of claim 1 wherein the sugar alcohol comprises maltitol and sorbitol.

10. The sugar free aerated confection of claim 1 wherein the whipping agent is selected from the group consisting of gelatin, vegetable protein, egg whites, egg albumen, milk proteins, caseinates, hydrocolloids, colloids, modified starches, edible gums and mixtures thereof.

11. The sugar free aerated confection of claim 10 wherein the gelatin has bloom strength of about 200 to about 275.

12. A process for making a sugar free aerated confection comprising the steps of forming a slurry comprising sugar alcohol, hydrogenated starch hydrolysate, hydrogenated saccharide and water, cooking the slurry and adding whipping agent either during or after the cooking step to form an emulsified candy mass wherein an ionic bridge comprising one or more metal salts is added in the process to emulsify the candy mass.

13. The process of claim 12 comprising the further step of aerating the emulsified candy mass with an aerating gas.

14. The process of claim 12 wherein the metal salts are selected from the group consisting of calcium chloride, sodium chloride, sodium hexametaphosphate, potassium chloride, magnesium chloride, magnesium phosphate, and combinations thereof.

15. The process of claim 12 wherein intense sweetener, flavoring, colorants and fillers are added during or after the cooking process.

16. The process of claim 12 comprising the additional step of coating the sugar free aerated confection.

17. The process of claim 16 comprising the additional step of treating the sugar free aerated confection with steam prior to or simultaneously with the coating step.

18. The process of claim 17 wherein the sugar free aerated confection is exposed to the steam at about 2 psi to about 15 psi for about 2 seconds to about 10 seconds.

19. The process of claim 12 wherein the slurry is cooked at about 245° F. to about 265° F. to obtain a dry solids content of about 85% to about 95%.

20. The process of claim 12 wherein the emulsified candy mass is cooled to a temperature of about 160° F. to about 230° F. prior to the aeration step.

21. The process of claim 12 comprising the additional step of forming the sugar free aerated confection into a product shape by means selected from the group consisting of molding, extruding, cutting and combinations thereof.
